(19) United States
(12) Patent Application Publication
(10) Pub. No.: US 2006/0136681 A1
(43) Pub. Date: Jun. 22, 2006

(54) Method and apparatus to support multiple memory banks with a memory block

(76) Inventors: Sanjeev Jain, Shresbury, MA (US); Gilbert M. Wolrich, Framingham, MA (US); Mark B. Rosenbluth, Uxbridge, MA (US); Debra Bernstein, Sudbury, MA (US)

Correspondence Address: Daly, Crowley & Mofford, LLP;c/o PortfolioIP, P.O. Box 52050, Minneapolis, MN, 55402, US

(21) Appl. No.: 11/018,023

(22) Filed: Dec. 21, 2004

(51) Int. Cl. G06F 13/00

(52) U.S. Cl. 711/154

(57) ABSTRACT

A memory controller system includes a memory command storage module to store commands for a plurality of memory banks. The system includes a plurality of control mechanisms, each of which includes first and second pointers, to provide, in combination with a next field in each module location, a link list of commands for a given one of the plurality of memory banks.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, network devices, such as routers and switches, can include network processors to facilitate receiving and transmitting data. In certain network processors, such as multi-core, single die IXP Network Processors by Intel Corporation, high-speed queuing and FIFO (First In First Out) structures are supported by a descriptor structure that utilizes pointers to memory. U.S. Patent Application Publication No. US 2003/0140196 A1 discloses exemplary queue control data structures. Packet descriptors that are addressed by pointer structures may be 32-bits or less, for example.

As is also known in the art, memory capacity requirements for control memory are increasing continuously with the increase in number of queues supported in networking systems. Typical SRAM (Static Random Access Memory) solutions, such as QDR (Quad Data Rate), memory technologies are limited in terms of memory capacity. As is well known, SRAM implementations are costly and consume a large amount of real estate as compared to DRAM (Dynamic Random Access Memory) solutions. However, some known DRAM implementations, such as RLDRAM (Reduced Latency DRAM), have memory that sort the memory commands for the different memory banks to maximize the memory bandwidth utilization. Existing memory controller designs use a separate FIFO for each memory bank resulting in large numbers of storage units, such as FIFOs (First In/First Out). For example for 8 bank designs, 8 FIFOs are used and for 16 bank designs, 16 FIFOs are used.

FIG. 1 shows a prior art bank-based memory controller 1 including a main command FIFO 2 to store commands and a bank management module 4 to sort commands based upon which of the memory banks 5a-h will handle the command. In the illustrated implementation there are eight FIFOs 6a-h, one for each memory bank 5a-h. A pin interface 7 is located between the memory banks 5a-h and the FIFOs 6a-h. A head/tail structure 8a-h for each FIFO can control data input and output from each FIFO 6a-h. In addition, a lookahead structure 9a-h for each FIFO 6a-h can facilitate data transfer to the pin interface 7.

With this arrangement, a number of FIFOs equal to the number of memory banks is needed requiring a relatively large amount of on chip area. In addition, if a bank FIFO is underutilized, unused storage cannot be given to the FIFO that is temporarily overstressed due to an excess of commands for a particular memory bank. If a bank FIFO fills up, a back pressure signal will be sent to the main command FIFO, which will in turn back pressure the entire system to so that no commands are lost. Back pressure signals decrease throughput and generally degrade system performance. Further, since each memory module has a separate full, empty, head pointer and tail pointer structure, eight sets of these structures are needed for an eight-bank memory, and so on.

### BRIEF DESCRIPTION OF THE DRAWINGS

The exemplary embodiments contained herein will be more fully understood from the following detailed description taken in conjunction with the accompanying drawings, in which:

FIG. 1 is a prior art memory controller implementation;

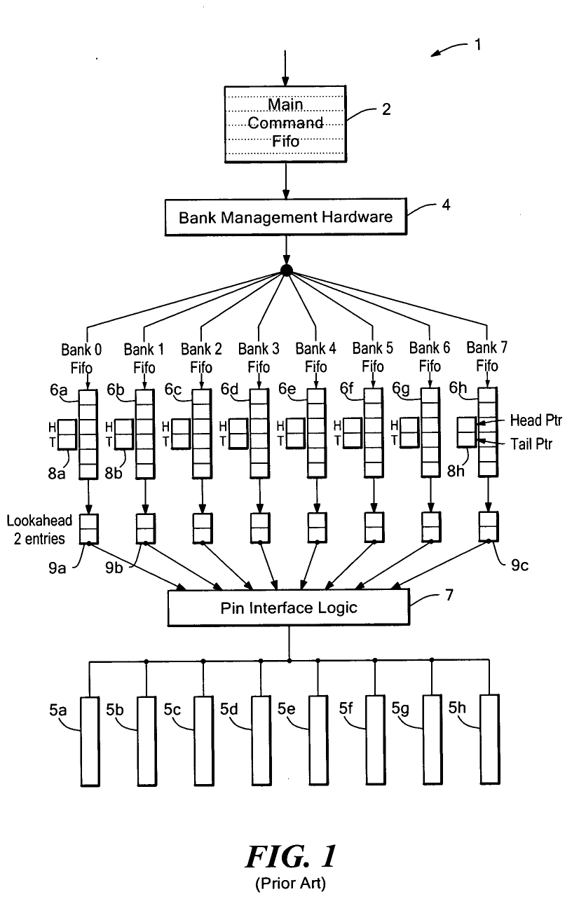

FIG. 2 is a diagram of an exemplary system including a network device having a network processor unit with a bank-based memory controller;

FIG. 2A is a diagram of an exemplary network processor having processing elements supporting a bank-based memory controller;

FIG. 3 is a diagram of an exemplary processing element (PE) that runs microcode;

FIG. 4 is a diagram showing an exemplary memory controller implementation;

FIG. 5A-5D show a sequence of storing and using commands in a memory controller; and

FIG. 6 is a schematic depiction of an exemplary memory bank and interface logic implementation.

### DETAILED DESCRIPTION

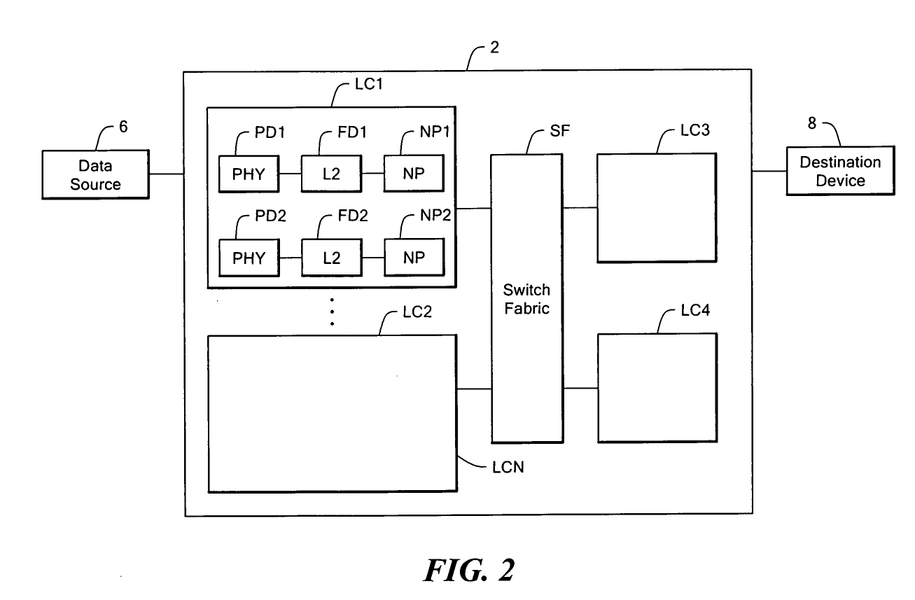

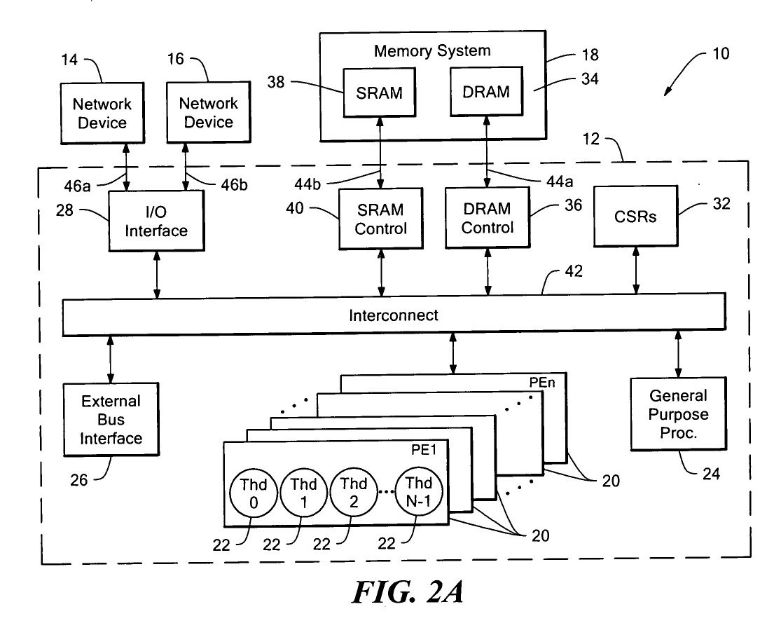

FIG. 2 shows an exemplary network device 2 including network processor units (NPUs) having a content addressable memory with a linked list pending queue to order memory commands when processing incoming packets from a data source 6 and transmitting the processed data to a destination device 8. The network device 2 can include, for example, a router, a switch, and the like. The data source 6 and destination device 8 can include various network devices now known, or yet to be developed, that can be connected over a communication path, such as an optical path having a OC-192 (10 Gbps) line speed.

The illustrated network device 2 can manage queues and access memory as described in detail below. The device 2 features a collection of line cards LC1-LC4 (“blades”) interconnected by a switch fabric SF (e.g., a crossbar or shared memory switch fabric). The switch fabric SF, for example, may conform to CSIX (Common Switch Interface) or other fabric technologies such as HyperTransport, Infiniband, PCI (Peripheral Component Interconnect), Packet-Over-SONET, RapidIO, and/or UTOPIA (Universal Test and Operations PHY Interface for ATM (Asynchronous Transfer Mode)).

Individual line cards (e.g., LC1) may include one or more physical layer (PHY) devices PD1, PD2 (e.g., optic, wire, and wireless PHYs) that handle communication over network connections. The PHYs PD translate between the physical signals carried by different network mediums and the bits (e.g., “0”-s and “1”-s) used by digital systems. The line cards LC may also include framer devices (e.g., Ethernet, Synchronous Optic Network (SONET), High-Level Data Link (HDLC) framers or other “layer 2” devices) FD1, FD2 that can perform operations on frames such as error detection and/or correction. The line cards LC shown may also include one or more network processors NP1, NP2 that perform packet processing operations for packets received via the PHY(s) and direct the packets, via the switch fabric SF, to a line card LC providing an egress interface to forward the packet. Potentially, the network processor(s) NP may perform “layer 2” duties instead of the framer devices FD.

FIG. 2A shows an exemplary system 10 including a processor 12, which can be provided as a network processor. The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, and so forth.

The devices 14, 16 can be any network devices capable of transmitting and/or receiving network traffic data, such as framing/MAC (Media Access Control) devices, e.g., for connecting to 10/100BaseT Ethernet, Gigabit Ethernet, ATM or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also be serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

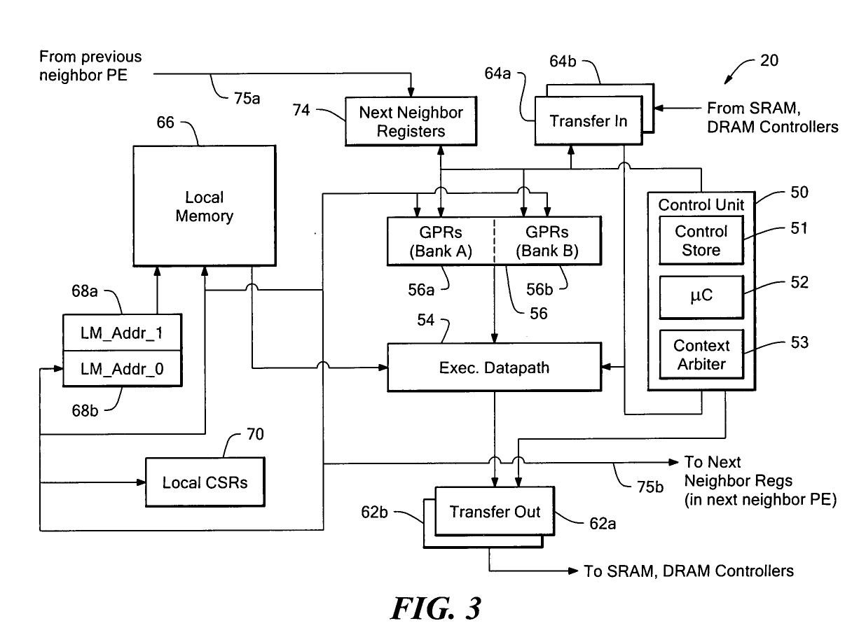

Referring to FIG. 3, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU (arithmetic logic unit), a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes a write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

While illustrative hardware is shown and described herein in some detail, it is understood that the exemplary embodiments shown and described herein for a content addressable memory with a linked list pending queue to order memory commands are applicable to a variety of hardware, processors, architectures, devices, development systems/tools and the like.

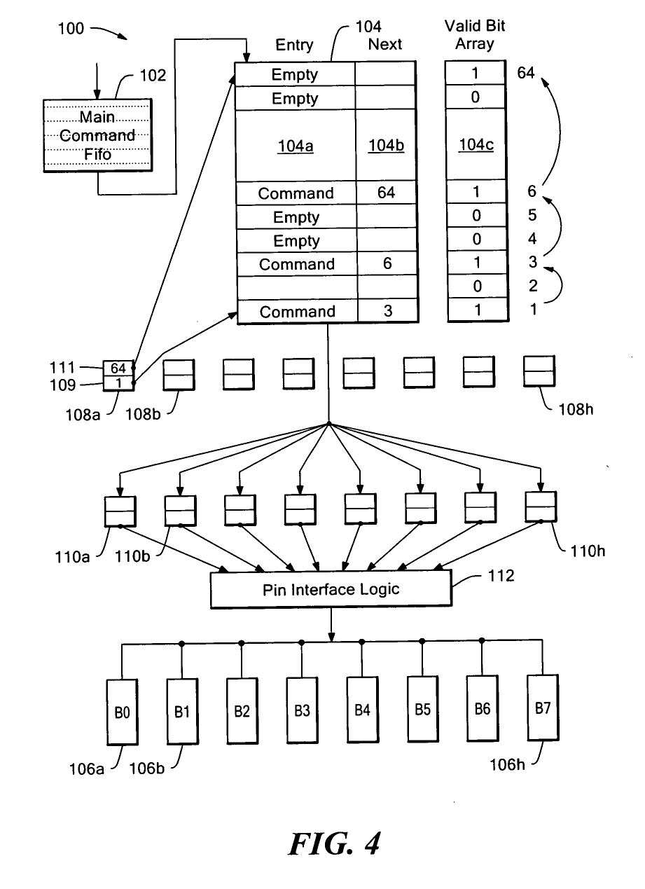

FIG. 4 shows an exemplary memory controller 100 including a main command FIFO 102 providing commands to a memory command storage module 104 to store commands for multiple memory banks 106a-h. A control mechanism 108a-h, which can include a head pointer and a tail pointer, for each memory bank 106a-h is coupled to the command storage module 104. An optional lookahead module 10a-h for each memory bank can be coupled in between the data egress port of the command storage module 104 and pin interface logic 112. As is known to one of ordinary skill in the art, the lookahead module 110 facilitates write command grouping and read command grouping for optimal memory operation efficiency. That is, transitioning from read to write command and/or vice-versa can waste memory cycles.

In an exemplary embodiment, each location in the command storage module 104 includes a command storage field 104a and a next field 104b, which points to the next entry in a link list of commands for a given memory bank. The command storage module 104 further includes a valid flag 104c, which can form a part of a “Valid Bit Array.” When the entry contains a valid command, or the head pointer is pointing to a particular entry, its corresponding valid flag 104c is set. After the entry has been used the valid flag 104c is reset and the entry enters the pool of available entries.

The control mechanism 108 includes a head pointer 109 and a tail pointer 111. Initially, the head and tail pointers 109,111 point to the same location that is assigned to the associated memory bank at initialization. Where the head and tail pointers point to the same location, it can be assumed that the command storage module 104 does not contain any commands for the associated memory bank. In general, each control mechanism 108, in combination with the command storage module 104, controls a link list of commands for each memory bank.

When a new command is received for a given memory bank, a free entry is determined from the valid flags 104c in the command storage module. The new command is written at the head pointer location and a next free entry location is identified and placed in the next field 104b. The tail pointer 111 is updated to point to the next free entry location. A link list of commands can be built using this mechanism.

When the pin interface logic 112 gets a new command from the command storage module 104, the tail pointer 111 is used to read the next command from memory pool. The tail pointer 111 is then updated with the entry number written at the next pointer location and the valid flag 104c corresponding to the used entry is reset.

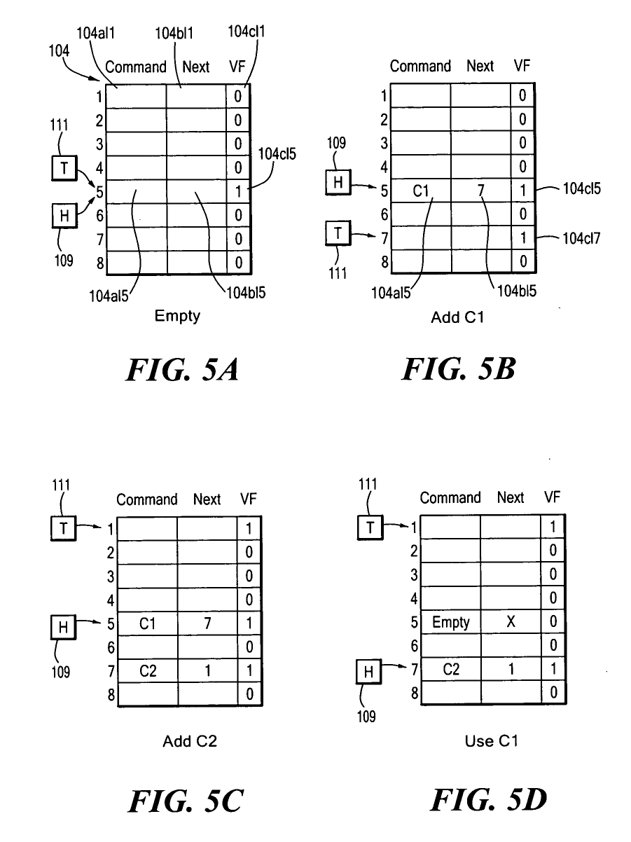

FIGS. 5A-C, in combination with FIG. 4, show an exemplary processing sequence of storing and using commands in the command storage module (FIG. 4) based upon the head pointer 109, tail pointer 111, and next field 104b of the command storage module. It is understood that the head and tail pointers 109, 111 control a link list of commands for a particular memory bank and that a head and tail pointer pair exist for each memory bank.

In FIG. 5A, the module 104 does not contain any commands for the bank that is connected with the head and tail pointers 109, 111 so that they point to the same location, shown as location 5, of the command storage module 104. Note that the valid flag 104cl5 for location 5 (l5) is set since the head pointer 109 points to this location. In FIG. 5B, a first command C1 from the main command FIFO 102 (FIG. 4) is stored in the command field 104al5 of location 5. As part of the command storage operation, a next entry location is identified based upon the valid flags 104c. In the illustrated embodiment, location 7 is identified as the next entry location and this information is written into the next field 104bl5 of location 5. The tail pointer 111 is updated to point to location 7 of the command storage module and the valid flag 104cl7 for location 7 is set.

In FIG. 5C, a second command C2 is received from the main command FIFO 102 and stored in location 7. The next entry location is identified as location 1 and this information is written to the next field of location 7. The tail pointer 111 is updated to point to location 1 and the valid flag for this location is set.

In FIG. 5D, the first command C1 is sent from the command storage module 104 to the lookahead structure 110 and pin interface 112. Location 5, which stored the first command C1 becomes empty and the valid flag 104c is reset. The head pointer 109 is updated to point to location 7, which contains the second command C2, and so on for subsequently received and used commands for a particular memory bank.

Since there is one command storage module 104 for multiple memory banks, instead of 8 or 16 memory modules, for example, as used in conventional implementations, significant improvements in memory module utilization is achieved. In addition, memory bank FIFOs (link lists) can grow or shrink to reduce or eliminate the number of backpressure occurrences.

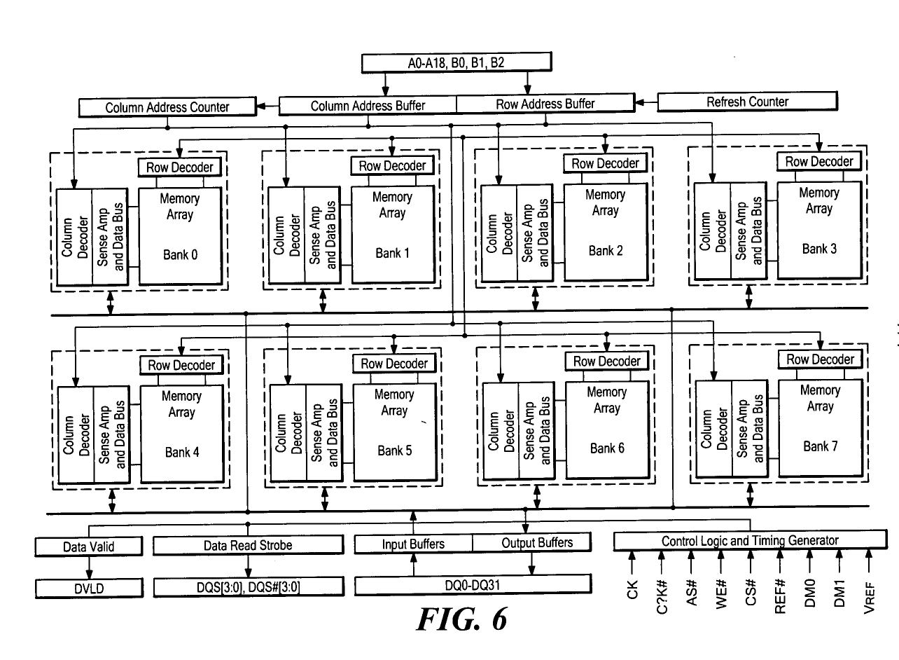

It is understood that a wide range of memory bank implementations are possible. FIG. 6 shows one embodiment of an eight-memory bank configuration that can be coupled to the pin interface logic 112 of FIG. 4. The pin interface logic 112 maximizes access to the memory banks by keeping track of what memory banks are available since an access to a given memory bank may make the bank unavailable for the next cycle or several cycles. Accesses to the various memory banks should be distributed in time to maximize memory access efficiency. In addition, while head and tail pointers are shown in exemplary embodiments, it is understood that other pointer structures can be used to meet the requirements of a particular implementation.

Other embodiments are within the scope of the following claims.

What is claimed is:

1. A memory controller system, comprising:
a memory command storage module to store commands for a plurality of memory banks, the memory command storage module including a plurality of locations each having a command storage field and a next location field; and
a plurality of control mechanisms coupled to the memory command storage module, each of the plurality of control mechanisms corresponding to a respective one of the plurality of memory banks, each of the control mechanisms including a first pointer and a second pointer, wherein the first pointer, second pointer, and next location field provide a link list of commands for a given one of the plurality of memory banks.

2. The system according to claim 1, wherein the first pointer points to a next command to be used, the second pointer points to a next location in which to store a command, and the next location field contains a pointer the next location pointed to by the second pointer.

3. The system according to claim 1, further including a main command storage device to provide commands to the memory command storage module.

4. The system according to claim 1, wherein each of the plurality of locations in the memory command storage module includes a valid flag.

5. The system according to claim 4, wherein the valid flag is set for a first location corresponding location when a command is stored there and/or the second pointer points to the location.

6. The system according to claim 4, wherein the valid flag is used to determine a next available location in the memory command storage module.

7. A network processor unit, comprising:
a memory controller system, including
a memory command storage module to store commands for a plurality of memory banks, the memory command storage module including a plurality of locations each having a command storage field and a next location field; and
a plurality of control mechanisms coupled to the memory command storage module, each of the plurality of control mechanisms corresponding to a respective one of the plurality of memory banks, each of the control mechanisms including a first pointer and a second pointer, wherein the first pointer, second pointer, and next location field provide a link list of commands for a given one of the plurality of memory banks.

8. The unit according to claim 7, wherein the first pointer points to a next command to be used, the second pointer points to a next location in which to store a command, and the next location field contains a pointer the next location pointed to by the second pointer.

9. The unit according to claim 7, further including a main command storage device to provide commands to the memory command storage module.

10. The unit according to claim 7, wherein each of the plurality of locations in the memory command storage module includes a valid flag.

11. The unit according to claim 7, wherein the network processor unit has multiple cores formed on a single die.

12. A network forwarding device, comprising:
at least one line card to forward data to ports of a switching fabric;
the at least one line card including a network processor unit having multi-threaded processing elements configured to execute microcode, the network processor unit, including:
a memory controller system, having
a memory command storage module to store commands for a plurality of memory banks, the memory command storage module including a plurality of locations each having a command storage field and a next location field; and
a plurality of control mechanisms coupled to the memory command storage module, each of the plurality of control mechanisms corresponding to a respective one of the plurality of memory banks, each of the control mechanisms including a first pointer and a second pointer, wherein the first pointer, second pointer, and next location field provide a link list of commands for a given one of the plurality of memory banks.

13. The device according to claim 12, wherein the first pointer points to a next command to be used, the second pointer points to a next location in which to store a command, and the next location field contains a pointer the next location pointed to by the second pointer.

14. The device according to claim 12, further including a main command storage device to provide commands to the memory command storage module.

15. The device according to claim 12, wherein each of the plurality of locations in the memory command storage module includes a valid flag.

16. The device according to claim 15, wherein the valid flag is used to determine a next available location in the memory command storage module.

17. A method of storing commands for a plurality of memory banks in a command storage module, comprising:
receiving a first command for a first one of the plurality of memory banks;
storing the first command in a command field of a first location in the memory command storage module;
updating a tail pointer of a head pointer/tail pointer pair to a next available location in the memory command storage module, the head pointer/tail pointer pair corresponding to the first one of the plurality of memory banks; and
storing a pointer to the next available location in a next location field of the first location of the memory command storage module, wherein the head pointer, tail pointer and the next location field provide a link list of commands for the first one of the plurality of memory banks.

18. The method according to claim 17, further including setting a valid flag for the next available location in the memory command storage module.

19. The method according to claim 18, wherein valid flag is set for the first location and determining another available location by examining valid flags for locations in the memory command storage module.

20. The method according to claim 17, further including transmitting the first command from the memory command storage module and updating the head pointer.

21. The method according to claim 17, further including updating further head/pointer pairs as further commands for other ones of the plurality of memory banks are received and transmitted.
